(19) United States
(12) Patent Application Publication
(10) Pub. No.: US 2006/0158836 A1
(43) Pub. Date: Jul. 20, 2006

(54) Display stand

(76) Inventor: Matthew C. Phillips, Portland, OR (US)

Correspondence Address: M.C. Phillips, 6901 SW Windemere Loop, Portland, OR, 97225, US

(21) Appl. No.: 11/318,380

(22) Filed: Dec. 23, 2005

Related U.S. Application Data
(60) Provisional application No. 60/638,598, filed on Dec. 23, 2004.

(51) Int. Cl. G06F 1/16

(52) U.S. Cl. 361/681

(57) ABSTRACT

A display stand, for use positioned to a side of a chair, holds an electronic display in a desirable position for comfortable viewing by a person seated in the chair. The display stand comprises a base, a support arm, and a connection for the display. The support arm has proximate and distal ends. The proximate end is connected to the base. The connection for the display is on the distal end of the support arm. The support arm is adjustable between first configuration and second configurations. The first configuration is characterized by the connection being positioned to the side of the chair and at a height approximately at or below the armrests. The second configuration is characterized by the connection being positioned at a height above the seat and forward of the seat back such that the person seated in the chair can comfortably view the electronic display.

### RELATED APPLICATION

This application is a continuation-in-part of U.S. Provisional Patent Application No. 60/638,598, entitled “Display Stand,” filed Dec. 23, 2004, which is incorporated by reference herein in its entirety, and to which priority is claimed pursuant to 35 U.S.C. § 119(e).

### TECHNICAL FIELD

The field of this disclosure relates generally but not exclusively to display stands, and more particularly to stands for supporting an electronic display, such as a computer display, or to chairs and seats having such display stands.

### BACKGROUND

Desks and tables are relics of the pre-computer age. They are well-suited for working with papers and documents, but they are an awkward match for displays, such as computer displays. While a display can be placed on the surface of a desk or table, it can be challenging, if not impossible, to position the display at a height and distance for comfortable viewing by a user sitting at the desk or table. It can be especially challenging to simultaneously position input devices, such as a keyboard and a mouse, in a comfortable position for use. It is believed that persons viewing such displays for extended periods of time can experience eye strain, back strain, neck strain, and other discomforts. While such mechanisms as sliding keyboard drawers or platforms and elevated display stands can be helpful, such mechanisms typically have limited adjustability, and chairs that are typically used in conjunction with a desk or table are typically less comfortable than chairs unassociated with a desk or table. Computer hutches are much the same as desks and have many of the same disadvantages. Desks, tables, computer hutches and the like are also bulky items that may not have a useful function other than holding a display and possibly computer equipment.

Laptop computers do not require a desk or table surface. A laptop computer can be used resting on a person's lap while sitting in a comfortable chair. However, while a keyboard on the lap is well positioned for comfortable typing, the laptop's display is at a low angle, and viewing a screen on your lap can cause neck strain. Various laptop computer trays and tables are available to elevate a laptop computer to a more comfortable viewing height for a person seated in a chair. However, with such tables and trays, if the screen is in a position for comfortable viewing, the keyboard is typically at too high a level for comfortable use. Furthermore, most such tables and trays typically must be positioned directly in front of the user, thereby preventing the user from raising his or her legs and making it difficult for the user to recline while maintaining a sufficiently close distance from the laptop screen for satisfactory viewing.

There are also various computer carts, such as, for example, the one shown in U.S. Design Pat. No. 507,266, in which a flat panel display and a keyboard tray attach to adjustable arms on a vertical pole extending up from a wheeled base. Use of such carts requires that the user be facing directly toward the pole, thereby limiting the user's ability to recline or to raise his or her legs. Furthermore, computer carts typically do not enable the display to be readily retracted, lowered considerably, set aside, or hidden from view.

### SUMMARY

According to one embodiment, a display stand is for use positioned to a side of a chair having a seat, a back, and an armrest. The display stand holds an electronic display in a desirable position for comfortable viewing by a person seated in the chair. The display stand comprises a base, a support arm, and a connection for the display. The support arm has a proximate end and a distal end. The proximate end is connected to the base. The connection for the display is on the distal end of the support arm. The support arm is adjustable between a first configuration and a second configuration. The first configuration is characterized by the connection being positioned to the side of the chair and at a height approximately at or below the armrest. The second configuration is characterized by the connection being positioned at a height above the seat and forward of the back such that the person seated in the chair can comfortably view the electronic display, when connected to the connection.

According to another embodiment, a chair comprises a generally horizontal seating surface, a plurality of legs connected to the seating surface, a seat back rearward from the seating surface, an armrest positioned above and laterally from the seating surface, a support arm, and a connection for an electronic display. The support arm has a proximate end and a distal end. The proximate end is connected to at least one of the seating surface, legs, or seat back. The connection for the electronic display is on the distal end of the support arm, which is adjustable between a first configuration and a second configuration. The first configuration is characterized by the connection being positioned laterally from the seating surface and at a height approximately at or below the armrest. The second configuration is characterized by the connection being positioned at a height above the seating surface and forward of the seat back such that a person seated in the chair can comfortably view the electronic display, when connected to the connection.

According to other embodiments, two or more of a display stand, display, chair, and/or image generating device, such as a computer, are optionally combined. The display stand may optionally comprise an enclosure in which the display stand, display, and/or image generating device may be contained.

Additional details concerning the construction and operation of particular embodiments are set forth in the following sections with reference to the below-listed drawings.

### BRIEF DESCRIPTION OF THE DRAWINGS

FIG. 1 is an isometric view of a display stand according to one embodiment.

FIG. 2 is an isometric view of a combination of a chair and the display stand of FIG. 1, according to one embodiment.

FIG. 3 depicts one version of a horizontal member and a display connection on the display stand of FIG. 1.

FIG. 4 is an isometric view of a display stand with a keyboard rack, according to one embodiment.

FIG. 5 is an isometric view of a display stand with a top shelf, according to one embodiment.

FIG. 6 is an isometric view of a display stand, according to another embodiment.

FIG. 7 is an isometric view of a display stand, according to yet another embodiment.

FIG. 8 depicts a display stand, according to yet another embodiment.

FIG. 9 is a diagram of a portion of a display stand, according to still another embodiment.

FIG. 10 is an isometric view of a chair with an integral display stand, according to another embodiment.

FIG. 11 is an isometric view of a chair with an integral display stand, according to another embodiment.

FIG. 12 depicts a combination of a chair and the display stand of FIG. 1, according to another embodiment.

FIG. 13 is an isometric view of the chair of FIG. 12 occupied by a person, according to one embodiment.

FIG. 14 is an isometric view of the chair of FIG. 12 occupied by a person, according to another embodiment.

FIG. 15 is a set of diagrams of a display stand according to another embodiment.

FIG. 16 is a pair of isometric views of a display stand according to another embodiment.

FIG. 17 is a pair of isometric views of a display stand according to another embodiment.

FIG. 18 is a pair of isometric views of a display stand according to yet another embodiment.

FIG. 19 is a partially exploded isometric view of a display stand with an enclosure cabinet, according to one embodiment.

FIG. 20 is a set of isometric views of a display stand with an enclosure cabinet, according to another embodiment.

### DETAILED DESCRIPTION OF EMBODIMENTS

With reference to the above-listed drawings, this section describes particular embodiments and their detailed construction and operation. As one skilled in the art will appreciate in light of this disclosure, certain embodiments are capable of achieving certain advantages over the known prior art, including some or all of the following: (1) decreased neck and back strain; (2) decreased eye strain; (3) the ability to view a display more comfortably by positioning the display at almost any desired, position, distance, and tilt with respect to one's eyes; (4) the ability to use a computer more productively for a longer time; (5) the ability to use a smaller, more economical display; (6) the ability to recline and/or raise one's legs while using a computer; (7) the ability to independently position a computer display and input device(s) at comfortable locations, such as a keyboard at lap level and a display at eye level; (8) the ability to reclaim desk and table space otherwise occupied by a computer; (9) the ability to use an existing chair and computer together in a useful and advantageous configuration; (10) the ability to use less expensive desktop and tower package computers rather than laptop computers; (11) a small footprint for a computer; (12) the ability to place a computer inconspicuously in a room with “fine” furniture; (13) the ability to retract, hide, or set aside a display when not in use; and (14) for merchants, the ability to drive sales of displays, computers, and/or chairs by bundling them together in various combinations with a display stand. These and other advantages of various embodiments will be apparent upon reading the remainder of this section.

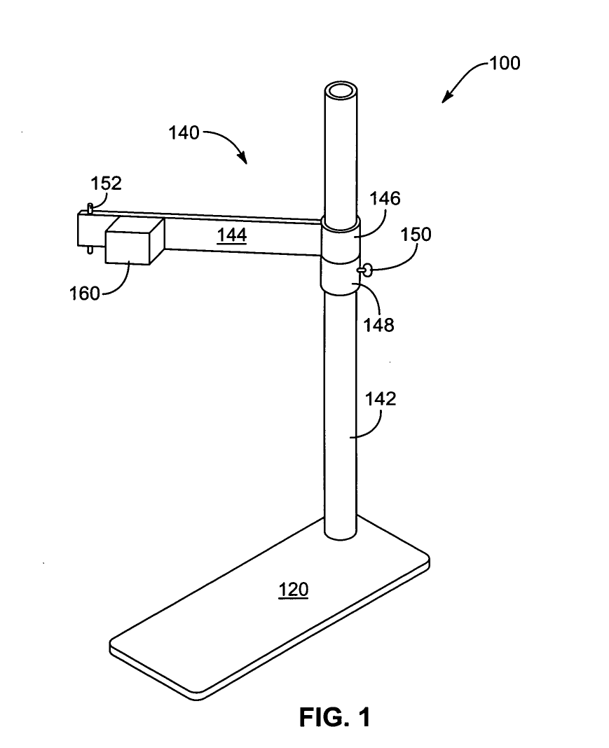

FIG. 1 is an isometric view of a display stand 100. The display stand 100 comprises a base 120, a support arm 140, and a connection 160 to which a display can be mounted. The base 120 is generally broad and flat and has a bottom side and a top side. The base 120 preferably has a shape and size generally matching the footprint of a tower style computer case so that such a computer can fit thereon. The bottom side of the base 120 may rest directly on the floor or another surface. Alternately, the base 120 may have feet, legs, or the like (not shown) on its bottom side, or the base 120 may have wheels, rollers, or the like (not shown) underneath it. Wheels, if present, are preferably inconspicuous and perhaps only along one edge or the base to facilitate occasional movement by slightly lifting the display stand 100 on the side opposite the wheels.

The support arm 140 comprises a vertical pole 142 and a horizontal member 144. The horizontal member 144 has a pivoting collar 146 that can preferably rotate around the vertical pole 142 and thereby cause the horizontal member to pivot about the center axis of the vertical pole 142. The vertical position of the horizontal member 144 can preferably be adjusted. A stop collar 148 fits around the vertical pole 142 and can be positioned vertically along the length of the vertical pole 142. The stop collar 148 provides a bottom support for the pivoting collar 146. The stop collar 148 comprises a handle 150 connected to a screw that releases or presses a pad (not illustrated) against the vertical pole 142 either to allow adjustment of the stop collar 148 or to hold the stop collar 148 in place by frictional contact of the pad against the vertical pole. The pad may have a surface made of a high-friction material, such as a rubber or plastic, for example.

The connection 160 is preferably slidably adjustable along a portion of the horizontal extent of the horizontal member 144, which may contain one or more horizontal tracks or grooves to prevent the connection 160 from rotating about the horizontal axis of the horizontal member 144. A protrusion 152 can be placed near the distal end of the horizontal member to prevent the connection from sliding off the horizontal member 144. The protrusion 152 is preferably removable to permit assembly and disassembly of the connection 160 onto the horizontal member 144.

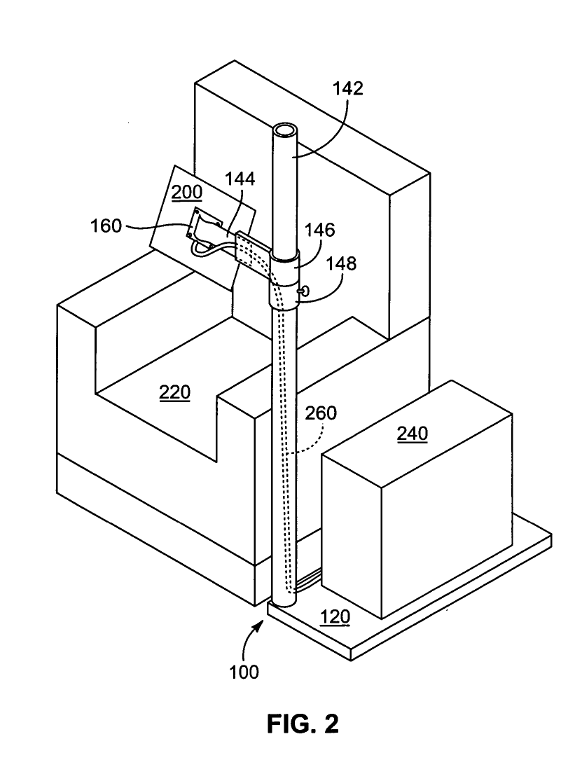

The display stand 100 is desirably used to mount and to hold a display 200 that can easily and comfortably be viewed by a person sitting on a chair 220 next to the display stand 100, as shown in FIG. 2, which is an isometric view of a combination of the chair 220 and the display stand 100, according to one embodiment. The chair 220 may be any chair but is preferably a comfortable chair, such as a recliner, for relaxed prolonged use. A footstool or ottoman (not illustrated) can also be used in conjunction with the chair 220.

By adjustment of the vertical height of the stop collar 148, adjustment of the angular position of the pivoting collar 146, adjustment of the position of the connection 160 along the length of the horizontal member 144, and/or pivoting of the mounting angle of the connection 160, the display 200 can be positioned to suit viewers having a wide variety of sizes and preferences. By positioning the display at a comfortable position for sustained viewing from a comfortably seated position, the display stand 100 can prevent or alleviate eye strain, back strain, and/or neck strain on the part of the user.

The display 200 is preferably a flat panel display, such as LCD (liquid crystal diode) or plasma display screen. However, any type of display that can be stably held by the display stand 100 can be mounted on an appropriate form of the connection 160.

Also shown in FIG. 2 is a computer console 240 sitting on the base 120. The weight of the display 200 may create a moment arm tending to topple the display stand 100 unless the display stand 100 is adequately counterbalanced. The computer console 240 preferably provides that counterbalance. Alternatively, the weight of the chair 220 can be placed fully or partially atop the base 120 to provide a counterweight, or the base 120 and/or the support arm 140 may be otherwise connected to the chair 220 to provide an overall stable arrangement. For example, the base 120 can be oriented at a 90 degree angle from what is illustrated in FIG. 2, such that the base 120 extends underneath the chair 220. If necessary, the base 120 itself may be made to have sufficient weight to counterbalance the display 200, but the stability of the display stand 100 is further enhanced by placing all or part of the weight of the computer console 240 and/or the chair 220 on the base 120. The computer console 240 is preferably in a tower-style case to minimize the footprint of the base 120.

More generally, the computer console 240 may be any image-generating device, such as a television receiver or video media (e.g., VHS tape or DVD) player.

Also shown in FIG. 2 is an electrical cable 260 connecting from the computer console 240 to the display 200. One or more cables, such as a power cable and a video signal cable, may be provided. The cable(s) 260 may be attached to the horizontal member 144 and the vertical pole 142 by any suitable means, such as clips or ties. Alternatively, the horizontal member 144 and/or the vertical pole 142 may be hollow, in which case the cable(s) 260 can be routed through the hollow interior portions of those members.

Because the display 200 may be positioned for ease of viewing, it can be smaller than would otherwise be required for desktop, tabletop, or laptop use. Thus, a smaller, lighter, and more economical display can be utilized. An advantage of a lighter display is that the moment arm created by it is commensurately smaller, thereby requiring less counterweight for a stable arrangement. Preferably, the display 200 weighs less than about 10 pounds. Presently there are a variety of flat panel displays weighing less than ten pounds. Such displays typically measure 15 or 17 inches diagonally between opposite corners and are modestly priced. One presently preferred display is a model PL 456s, from Proview Technology Inc., Garden Grove, Calif., an inexpensive display weighing approximately 4.5 pounds and having a 14 inch diagonal screen size. Of course, larger, heavier displays can also be utilized with the display stand 100, provided the display stand 100 is designed to have adequate structural strength and stability against tipping.

A person seated in the chair 220 and viewing the display 200 enjoys a comfortable experience that can be sustained for prolonged periods without undue strain on the person's eyes, neck or back. When the display 200 is a computer display, the person additionally can comfortable type or mouse on her or his lap. Optionally, the person can employ a lap desk (i.e., a surface with a deformable back such as a fabric-enclosed, bean- or pellet-filled back) to hold a keyboard and/or mouse pad. Alternatively, the chair 200 may be provided with a relatively broad, generally flat arm rest on which a mouse pad can be placed. Other options for holding or storing input devices are described herein below.

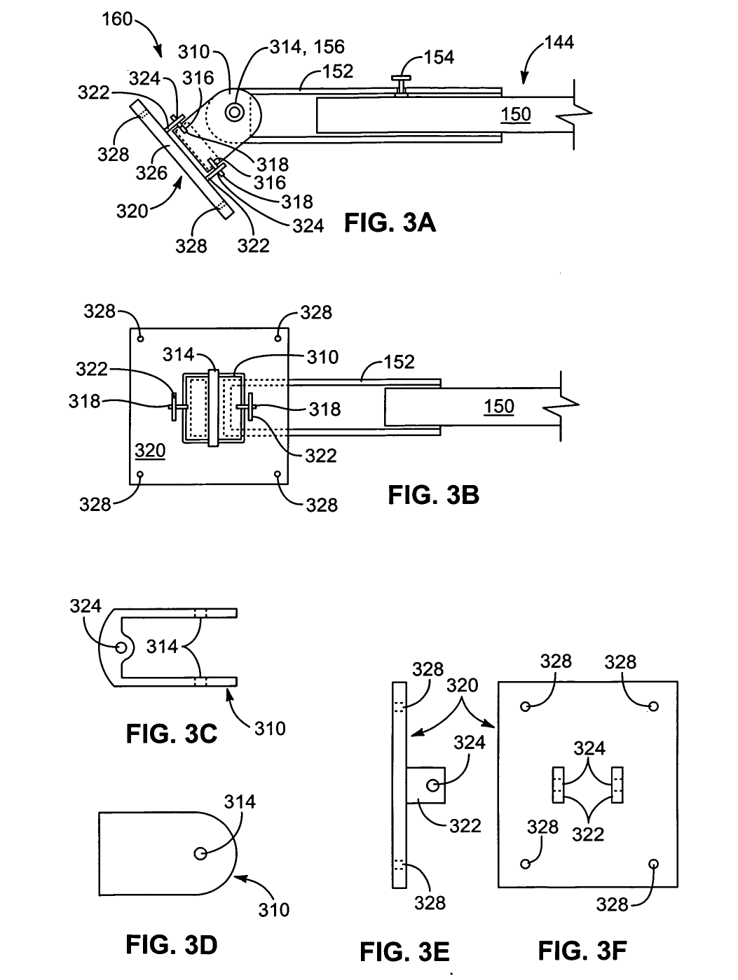

FIGS. 3A and 3B are top and side views, respectively, of one type of the horizontal member 144 and the display connection 160. In this form, the horizontal member 144 of the support arm 140 comprises an inner member 150 and an outer member 152. The inner member 150 attaches to the pivoting collar 146 around the vertical pole 142, while the outer member 152 has a hollow interior shaft dimensioned to fit snugly around the inner member 150 so that the inner member 150 and the outer member 152 can slide horizontally with respect to one another. The inner member 150 and the outer member 152 may contain mating horizontal grooves and flutes (not illustrated) to prevent rotation of the outer member 152 about the inner member 150. Optionally, a screw or bolt attached on one end to a handle 154 and attached on its other end to a pad (not shown) can be tightened to frictionally hold the inner member 150 and the outer member 152 in place. To adjust the length of the horizontal arm 144, a user can loosen the pad by turning the handle 154, slide the members into a desired position, and then hold them in place by tightening the handle 154.

The distal end of the outer member 152 preferably has a semi-circular top profile, in the center of which is a circular hole 154 therethrough from top to bottom. At the distal end of the outer member 152 is one form of the connection 160, which comprises two principle pieces: a first joint piece 310 and a second joint piece 320 cooperating to form a universal joint. The first joint piece 310 is illustrated in isolation in FIGS. 3C and 3D, which are a side view and a top view, respectively, of the first joint piece 310. The first joint piece 310 can rotate in a horizontal plane about a pin 312 passing through the hole 154 in the outer member 152 and through corresponding holes 314 in the first joint piece. The first joint piece 310 also contains two side holes 316, in which pins 318 can be inserted. The backside of the second joint piece 320 comprises stubs 322 in which are located corresponding holes 324 also accepting the pins 318. In this way, the angular pitch of the second joint piece 320 with respect to the first joint piece 310 can be adjusted. The second joint piece 320 also comprises a front mounting plate 326, in which are located four mounting holes 328. The mounting holes are preferably arranged in a square grid arrangement about 3 inches apart along each side, to match apparent standard mounting hardware on the rear of most flat panel displays. The mounting holes 328 are preferably threaded to accept bolts, also in accordance with apparent standard rear mounting hardware for flat panel displays. The second joint piece 320 is shown in isolation in FIGS. 3E and 3F, which are a side view and a rear view, respectively, of the second joint piece 320.

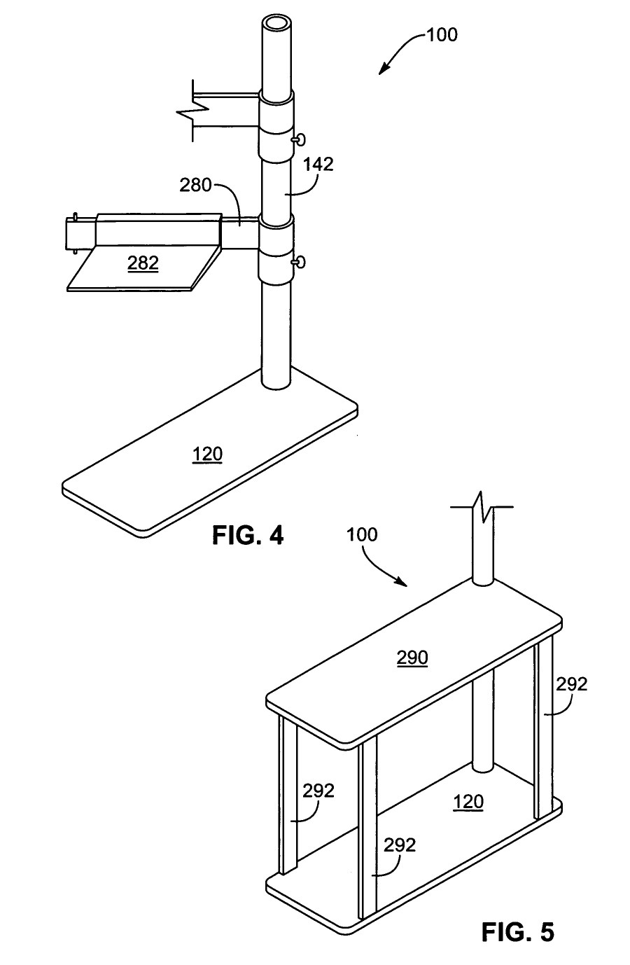

According to one embodiment, the display stand 100 optionally includes a second horizontal member 280 connecting to the vertical pole 142 and supporting a keyboard tray 282, as shown in FIG. 4. The tray 282 is a convenient area to place a keyboard, mouse, and/or other input device(s) for use with the computer console 240 and/or the display 200.

According to another embodiment, the display stand 100 optionally includes a shelf 290, as shown in FIG. 5. The shelf 290 is supported by legs 292 extending between the base 120 and the shelf 290. The shelf 290 provides a top surface convenient for placing a keyboard, mouse, books, or other equipment that may be used by a viewer of the display 200.

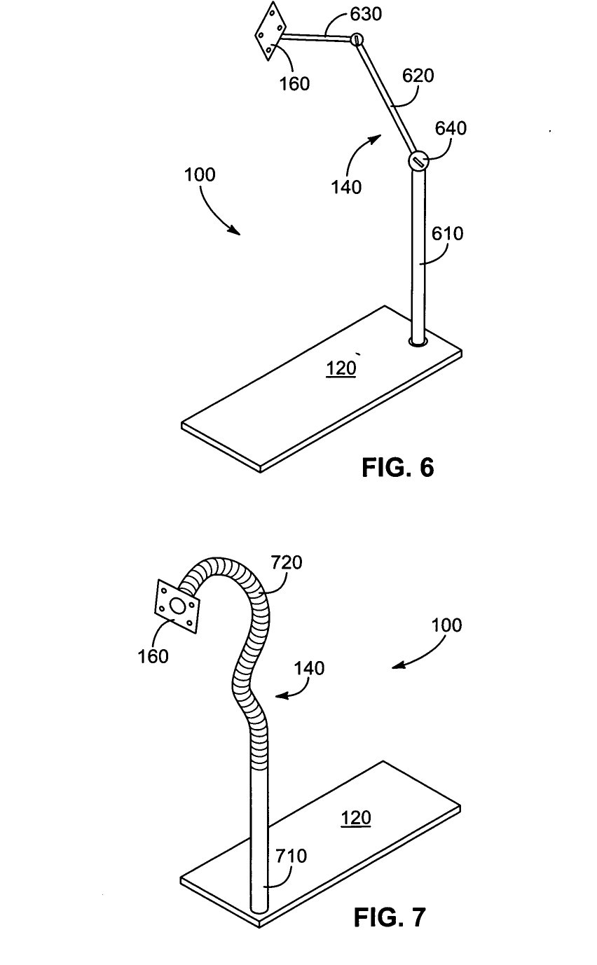

FIG. 6 is a isometric view of the display stand 100, according to another embodiment, in which the support arm 140 comprises three straight segments 610, 620, and 630 connected serially with articulating joints 640. A greater or lesser number of segments can be included, if desired.

FIG. 7 is a isometric view of the display stand 100, according to yet another embodiment, in which the support arm 140 comprises a semi-rigid tube 720 section connected atop an optional rigid vertical pole 710. The semi-rigid tube 720 can be gooseneck tubing, such as of the same general type as in the SNAKELIGHT(™) flashlights but of a larger diameter, strength, and rigidity.

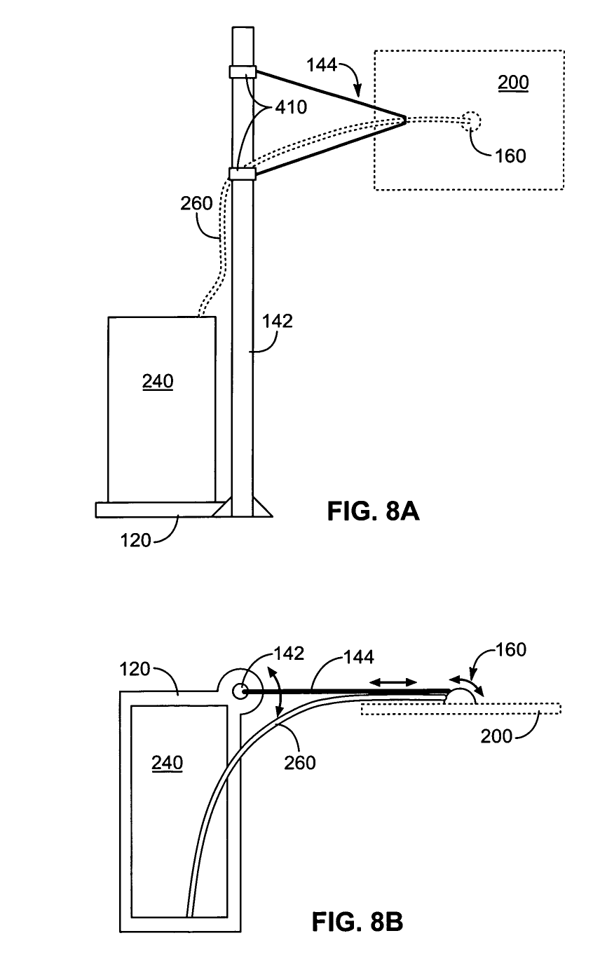

FIG. 8 depicts a display stand, according to yet another embodiment. FIG. 8A is a side view and FIG. 8B is a top view. According to this embodiment, the horizontal member 144 has two bars or other similar structural members connected to respective collars 410 fitting around the vertical pole 142 at the proximate end of the horizontal member 140. The horizontal member 144 can preferably be adjusted vertically along the vertical pole 142 and secured at a desired height. The horizontal member 144 is preferably extendible in the horizontal direction by an appropriate mechanism, such as sliding members. Connected to the distal end of the horizontal member 144 is the connection 160 for holding the display 200. The connection 160 is preferably rotatable horizontally and/or vertically. The connection 160 may comprise, for example, a ball and socket joint that provides twisting and rotation in all directions. This can be especially advantageous when the display 200 is configurable for viewing in two orthogonal orientations (e.g., regular and sideways).

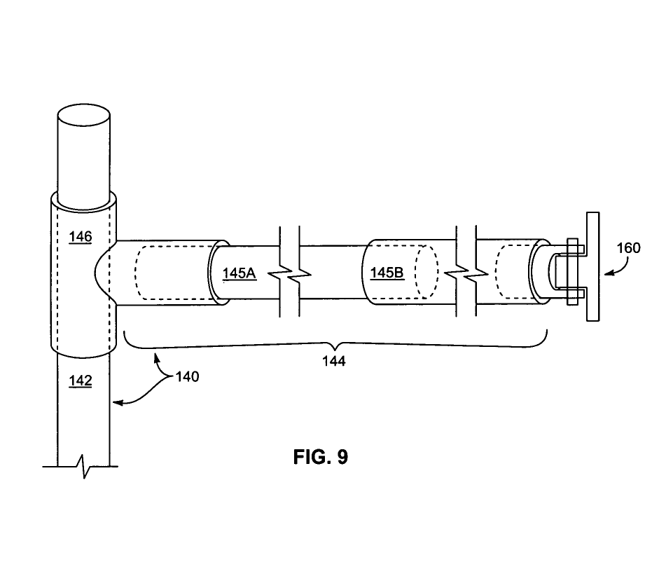

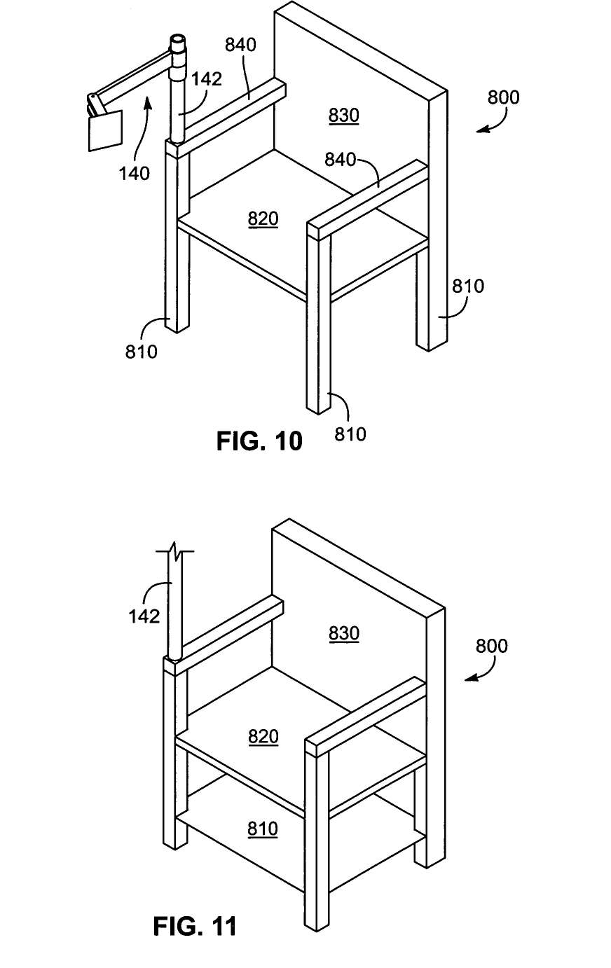

FIG. 9 is an isometric view of a portion of one alternative embodiment of the support arm 140. In this embodiment, the collar 146 is like a T-joint piping piece, the T-“top” portion of which is mounted on the vertical pole 142 and preferably rotatable about the vertical pole 142 at a desired adjustable height. The T-“leg” portion of the collar 146 holds the proximate end of a first horizontal sub-member 145A fitted in the interior of the T-leg portion. The distal portion of the first horizontal sub-member 145A fits within the interior portion of the proximate end of a second horizontal sub-member 145B, which is preferably like a pipe or tube. Within the interior portion of the distal end of the second horizontal sub-member 145B is fitted the connection 160, which may comprise a universal joint, as shown. The universal joint preferably provides 180-degree rotation in two orthogonal directions and is preferably also rotatable about the axis of the second horizontal sub-member 145B.

FIG. 10 is an isometric view of a chair 800 with an integral display stand, according to one embodiment. The chair 800 comprises four legs 810, a seating surface 820, a back rest 830, and two arm rests 840. The chair 800 may be of any type, preferably highly relaxing, like a recliner with a high back rest and a retractable foot support (not illustrated). The chair 800 may be highly padded, upholstered, etc. to enhance comfort. Attached to the chair is the support arm 140, generally as described herein. Alternative designs of the support arm 140 are, of course, possible. For example, the type of support arms utilized in architect style lamps can be employed, if designed to be sturdy enough. The support arm 140 is preferably connected to the a front leg coaxially, as shown, such as the vertical pole 142 being inserted in a hole bored or drilled into a front leg 810 or other solid section of the chair 800. The chair 800 may have sufficient weight to counterbalance the display 200 (not illustrated).

Alternatively, the support arm 140 can be retrofitted to the chair 800, such as, for example, by connecting the vertical pole 142 to one of the front legs 810 or to another suitable part of the chair 800.

FIG. 11 is an isometric view of the chair 800 according to another embodiment. According to this embodiment, the chair 800 comprises a shelf 850 under the seating surface 820. The shelf 850 may be a platform, basket, compartment, or the like. The shelf 850 is preferably dimensioned and structurally engineered to hold a computer base or console in a so-called desktop-style case (i.e., generally broader across and depthwise than its height). Alternatively, a tower-style case (i.e., generally taller than it is broad and deep) (not illustrated) can be housed in an appropriate area behind the back rest 830 or to either side of the chair 800, such as under an arm rest.

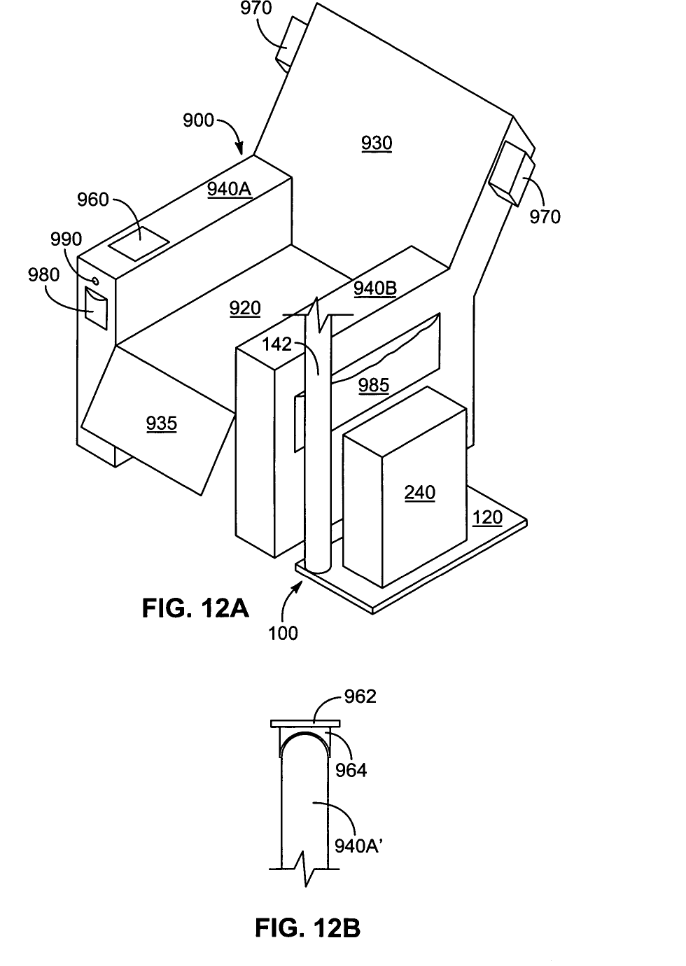

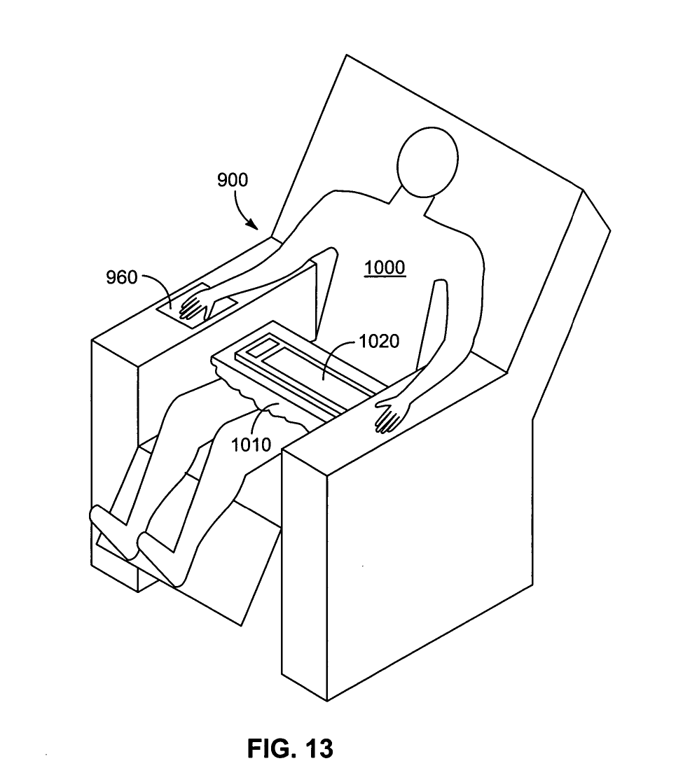

FIG. 12A is an isometric view of a combination of a chair 900 and the display stand 100, according to another embodiment. The chair 900 comprises a seating surface 920, a back rest 930, a foot rest 935, and right and left arm rests 940A and 940B. The chair 900 is preferably a recliner, such that the back rest 930 can incline in the rear direction. In such an inclined position, the seating surface 920 may optionally tilt its rear section down and/or its forward section upward. The foot rest 930 provides an inclined and/or elevated surface for a person (not shown) seated on the chair 900 to raise his or her legs and/or feet. Such a chair 900 is believed to be more comfortable than typical office, desk, or table-use chairs and therefore provides a more enjoyable and sustainable viewing experience when used with the display stand 100 and the display 200 (not shown). With sufficient adjustability in the positioning of the display 200, a desired viewing position can be achieved over a range of inclining positions. Because the pertinent portions of the display stand 100 are positioned to the side of the chair 900, the display stand 100 itself does not restrict either the ability to raise one's feet or to incline one's back while seated in the chair, unlike certain prior art computer carts or stands that must be placed directly in front of the user. In other words, the display stand 100 does not inhibit and in fact accommodates semi-prone positions for the viewer.

One or both of the arm rests 940A and/or 940B is preferably flat and wide enough to accommodate a mouse (not shown) and firm enough to permit mouse operation thereon. (As used herein, the term “mouse” encompasses all manner of mice, mice-like devices, roller balls, joysticks, touch pads, and other similar pointing or screen navigation devices.) For example, a width of about four inches is sufficient for a typical roller mouse, although a narrower area can work acceptably although perhaps with more frequent “pick ups” of the mouse. As shown in FIG. 12A, the arm rest 940A has on it a mouse pad 960, which may be built into the arm rest 940A but is preferably a loose item simply placed on the armrest 940A. FIG. 12B shows an upper portion of an alternative arm rest 940A′ with a curved top. Placed atop the arm rest 940A′ is a mouse pad having a generally flat sufficiently firm top surface 962 and a bottom piece 964 having a bottom shape generally matching that of the top of the arm rest 940A′. The top surface 962 of the mouse pad may be broader than the arm rest 940A′ to facilitate easier mousing operations. The bottom piece 962 may be made of foam, for example, and may be colored or covered in material matching that of the chair 900. Although two arm rests are preferred, it is possible to have only one (for mousing) or none.

The chair 900 also optionally has connected to it two speakers 970, as shown in FIG. 12A. The speakers are electrically connected to the computer console 240 or other image (and sound) generating device on the display stand 100 to play audio corresponding to the images on the display 200. The speakers 970 preferably comprise a stereo pair. The speakers 970 preferably are connected to mechanical speaker connections or mounts provided on the chair 900. The speakers 970 are preferably placed at or near ear level for a person sitting in the chair 930 and can preferably be adjusted at various heights along the back rest 930. The speakers 970 may be mounted on the exterior of the chair 900 or may be built in underneath the upholstery or other covering of the chair 930. Additional speakers (not shown) may also be provided on or within the chair 900. For example, a subwoofer (not shown) can be placed under the seating surface 920, a center speaker can be placed on or in the center top portion of the back rest 930. Alternatively or additionally, one or more speakers can be placed in or under the arm rests 940A and/or 940B. For example, a five-speaker “surround” set can be placed on or within the chair 900. As yet another embodiment, only a single speaker can be provided, for example on or near the top of the back rest 930 or elsewhere. Electrical wire connecting the speakers 970 to the computer console 240 or other image (and sound) generating device can be routed in the interior of the chair 900 or along its exterior. Alternatively, the speakers 970 may be linked wirelessly to the console 240.

The chair 900 also optionally includes a pocket 980 for storage of a mouse when not in use, as well as a pocket 985 for storage of a keyboard (not shown) when not in use. The mouse and/or keyboard preferably communicate wirelessly with the computer console 240 wirelessly to minimize cord traffic around the chair 900. This is less of a problem when the display stand 100 is on the same side of the chair as the mouse is used, unlike as shown in FIG. 12A. Alternatively, mouse and/or keyboard cords may be routed within the chair 900 or along its exterior to keep the cords hidden from sight and/or out of the way of people using the chair 900. As one example, a hole 990 is provided in the upholstery of the chair 900 near the mouse pad 960 and the mouse pocket 980, through which a mouse cord can be inserted and routed within the chair interior to the computer console 240. One or both of the pockets 980 and 985 can be built into the chair 900 or retrofitted to the chair 900, such as on a cloth or sheet that hangs over an arm rest and is secured on its opposite end by, for example, being tucked under a cushion on the seating surface 920.

FIG. 13 is an isometric view of the chair 900 occupied by a person 1000, according to one embodiment. The display stand 100 and the display 200 are not shown in FIG. 13 so as not to obscure the features described with reference to this figure, although it is understood that a display and display stand as herein described are adjacent to the chair 900 on one lateral side or the other. As shown, the person 1000 is operating a mouse on the mouse pad 960. On the lap of the person 1000 is a lap desk 1010 supporting a keyboard 1020. It is believed that operation of the keyboard 1020 at or near lap level is a comfortable configuration capable of sustained use with minimized fatigue and strain on the fingers, wrists, arms, and shoulders. The same is believed to be true for operation of a mouse at the level of a typical armrest. By allowing separation of the input devices from the display, the embodiments described herein can provide both optimum viewing conditions and optimum input entry positions in a comfortable chair apart from a desk or table, unlike some prior art devices, which trade off comfort in viewing for comfort in input entry by physically coupling the display and the input entry devices.

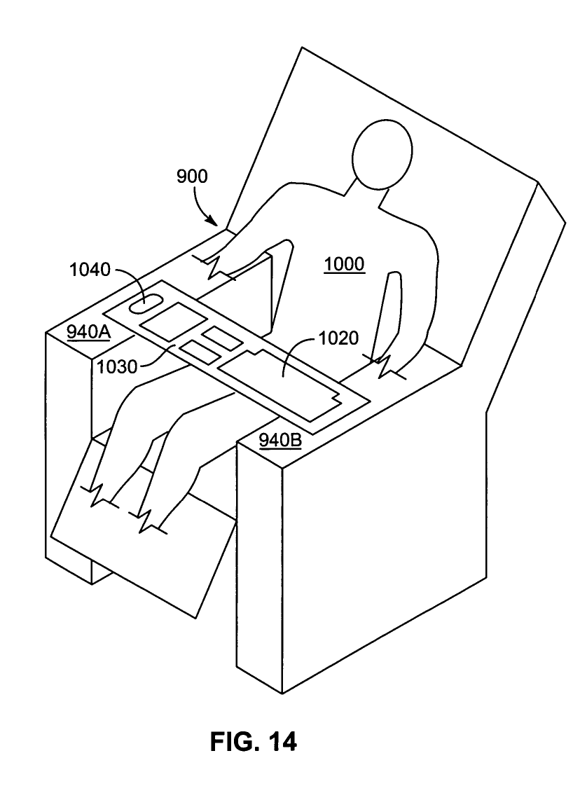

FIG. 14 is an isometric view of the chair 900 occupied by the person 1000, according to another embodiment. In this embodiment, the person 1000 is utilizing a tray 1030 placed on the arm rests 940A and 940B generally across his or her lap. The tray 1030 is preferably dimensioned of sufficient size to fit both a keyboard 1020 and a mouse 1040. The tray 1030 is especially well suited for use with chairs having narrow or odd shaped arm rests, unlike the ones shown in FIG. 14. The tray 1040 may be a wooden board or made of any other suitable material. The underside of the tray 1040 may optionally be covered or coated with a soft material to prevent scratching or abrasion against the armrests 940A and 940B.

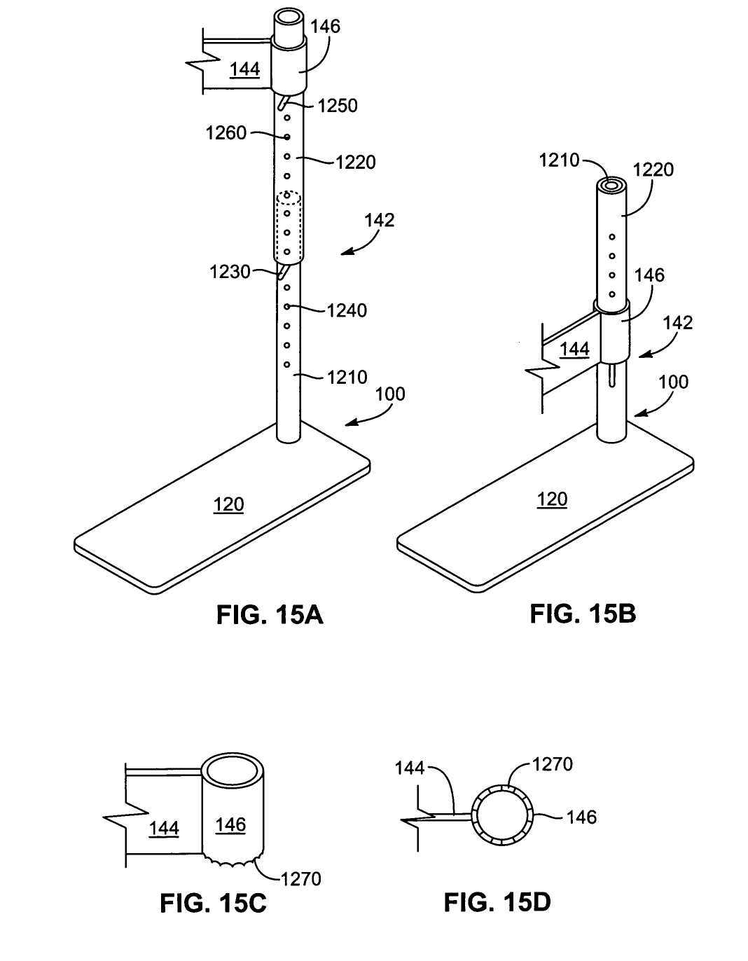

FIGS. 15-18 are diagrams of various versions of the display stand 100 in which the vertical pole 142 is extendible and retractable. One advantage of these versions of the display stand 100 is that it can be practically beneficial and aesthetically more pleasing to lower the vertical arm 142 when the display stand 100 is not in use. Preferably, the vertical pole 142, the connection 160, and/or the display 200 lowers to a height approximately at or below the top of the armrest to which it is adjacent. At such a level, the vertical pole 142 does not appreciably obstruct movement or vision across the area laterally adjacent to the chair. Furthermore, that height is convenient for enclosing the display stand 100 and display 200 in something that can be made to resemble an end table.

FIGS. 15A and 15B depict one version of the display stand 100 in which the vertical pole 142 comprises a lower inner portion 1210 and an outer portion 1220 that can move vertically with respect to the lower inner portion 1210 in a telescoping manner. A proximate end of the lower inner portion 1210 is connected to the base 120, and the distal end of the outer portion 1220 is connected to a horizontal member 144. The horizontal member 144 may be of any type, having any manner of connection 160 at its distal end, details of which are not included in this figure, so as not to obscure from the features described with reference to this figure. FIG. 15A shows the vertical pole 142 in a raised state, and FIG. 15B shows the vertical pole 142 is a lowered state. The outer portion 1220 may be locked relative to the lower inner portion by any means. One such mechanism is illustrated in FIG. 15A: a hole and peg system, whereby a peg 1230 can be placed partially or fully in one of a variety of holes 1240, which may extend partially or fully through the lower inner portion 1210. The bottom of the outer portion 1220 can rest on the peg 1230, as shown. Alternatively, one or more corresponding holes can be made in the outer portion such that the two portions lock via the peg 1230 placed through corresponding holes in both the outer portion 1220 and the lower inner portion 1210.

Disposed about the outer portion 1220 is the collar 146 connected to the horizontal member 144. The collar 146 can preferably be rotated about the outer portion 1220 to set a desired viewing position and distance for the display 200 (not shown). To support the collar 146 at a desired height and to lock the collar 146 in an angular position around the outer member 1220, a peg 1250 is inserted into a hole 1260 in the outer portion 1220. Divots 1270 along the bottom of the collar 146 fit over the peg 1250 to prevent rotation of the collar 146 about the outer portion 1220, as shown in FIGS. 15C and 15D which are enlarged side perspective and bottom views, respectively, of the collar 146. Alternatively, rather than divots 1270 along the bottom of the collar 146, holes can be made in the collar 146 to accommodate the peg 1250. Those skilled in the art will recognize that many other mechanisms can be employed to adjust and hold the lower inner portion 1210, outer portion 1220, and collar 146 in a desired configuration. Rather than exhaustively describe all such mechanisms, the foregoing mechanisms are presented as representative ones.

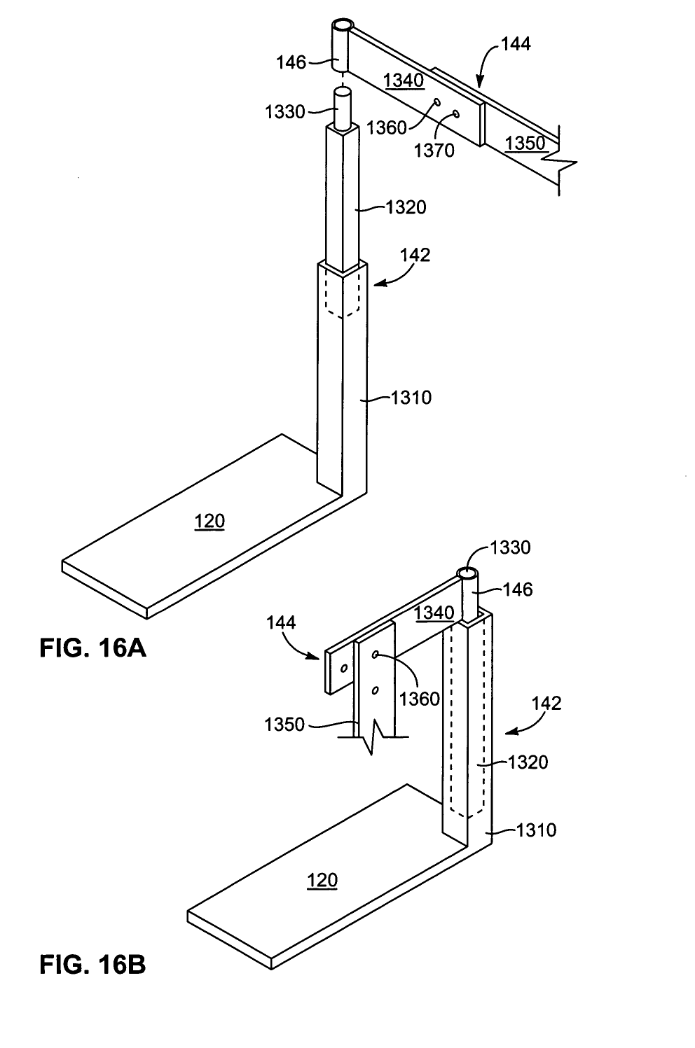

FIGS. 16A and 16B are isometric views of another version of the display stand 100 in respective raised and lowered positions. In this version, the vertical pole 142 comprises a lower outer portion 1310 and an inner portion 1320 that telescopically rises or lowers within a corresponding cavity or tunnel in the lower outer portion. At the distal end of the inner portion 1320 is a cylindrical segment 1330, about which fits the collar 146, as shown in exploded form in FIG. 16A and non-exploded form in FIG. 16B. The horizontal arm 144 in this version has two sections: a proximate section 1340 and a distal section 1350. The two sections 1340 and 1350 are connected such that when the vertical pole 142 is extended (as in FIG. 16A), the sections 1340 and 1350 are securely attached generally parallel to one another to extend the display (not shown) horizontally to a desired viewing position and distance, and such that when the vertical pole 142 is lowered (as in FIG. 16B), the display can be further lowered if desired. One such mechanism is depicted, it being understood that those skilled in the art will appreciate in light of the teachings herein that many different mechanism can accomplish the same goal. The mechanism depicted in FIG. 16 comprises a pin 1360 about which the sections 1340 and 1350 pivot, and a locking pin 1370 that can be inserted into appropriate holes to hold the sections in an extended position (FIG. 16A) or removed to allow the distal section 1350 to take a generally vertical orientation, as shown in FIG. 16B. The lengths of the lower outer portion 1310 and the sections 1340 and 1350 can be chosen such that a display of a given size fits above the base 120 and next to the lower outer portion 1310 when in the lowered position.

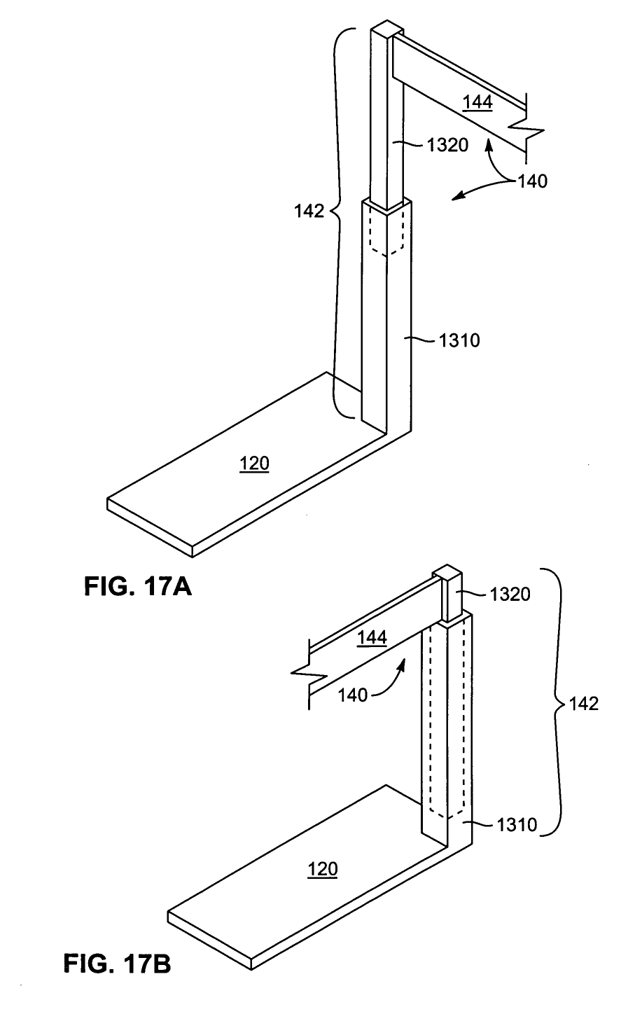

FIG. 17 shows an alternative embodiment of the display stand 100 with a support arm 140. As compared to FIG. 16, the horizontal member 144 of the support arm 140 is fixed to the upper portion 1320 in FIG. 17. Angular adjustment of the direction of the horizontal member 144 is limited to four positions offset by 90 degrees, such as a raised viewing orientation shown in FIG. 17A and a lowered storage orientation shown in FIG. 17B. The upper portion 1320 of the vertical pole 142 is completely removed from and reinserted into the lower outer portion 1310 of the vertical pole 142 to change its angular position. An advantage of the embodiment shown in FIG. 17 is simplicity of construction when less user adjustability is needed.

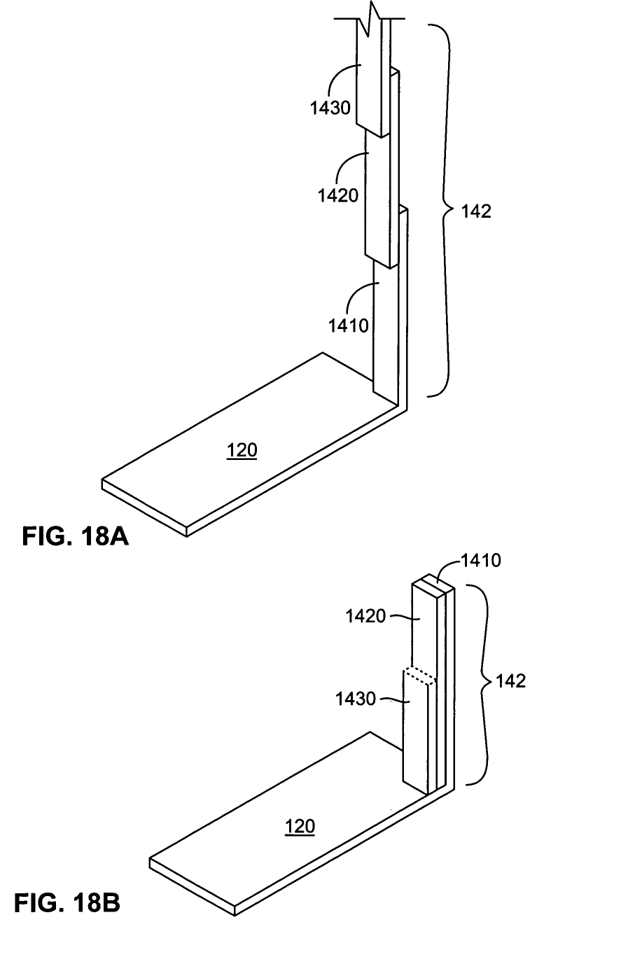

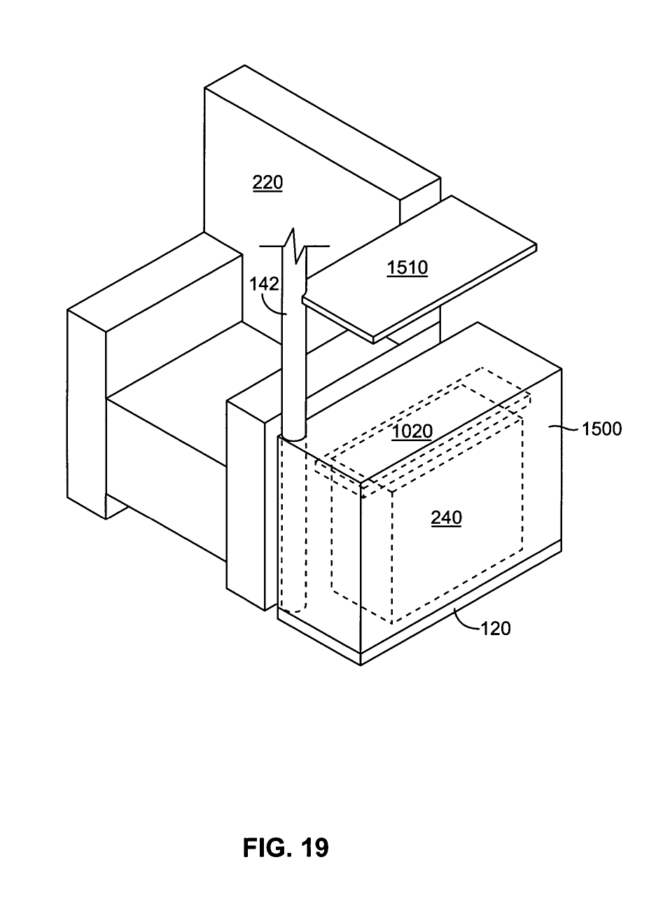

FIG. 18 is an isometric view of yet another version of the display stand 100. In this embodiment, the vertical pole 142 comprises a first portion 1410, a second portion 1420, and a third portion 1430—which are side-by-side sections. Each such portion can be raised or lowered with respect to its adjacent sections by any suitable mechanism (e.g., tracks, tongue in groove, etc.). The details of the distal end of the third section 1430 are omitted from both FIGS. 18A (raised configuration) and 18B (lowered configuration). Although the portions 1410, 1420, and 1430 are shown arranged in a progression in the long direction of the base 120, the portions 1410, 1420, and 1430 could alternatively be arranged in another direction, such as in the orthogonal short direction of the base 120.

In all of the versions of the display stand 100 with a retractable/extendible vertical pole 142, as shown in FIGS. 15-18, a greater or lesser number of portions of the vertical pole 142 can be utilized, and the portions could be raised and/or lowered by a motorized means, if desired.

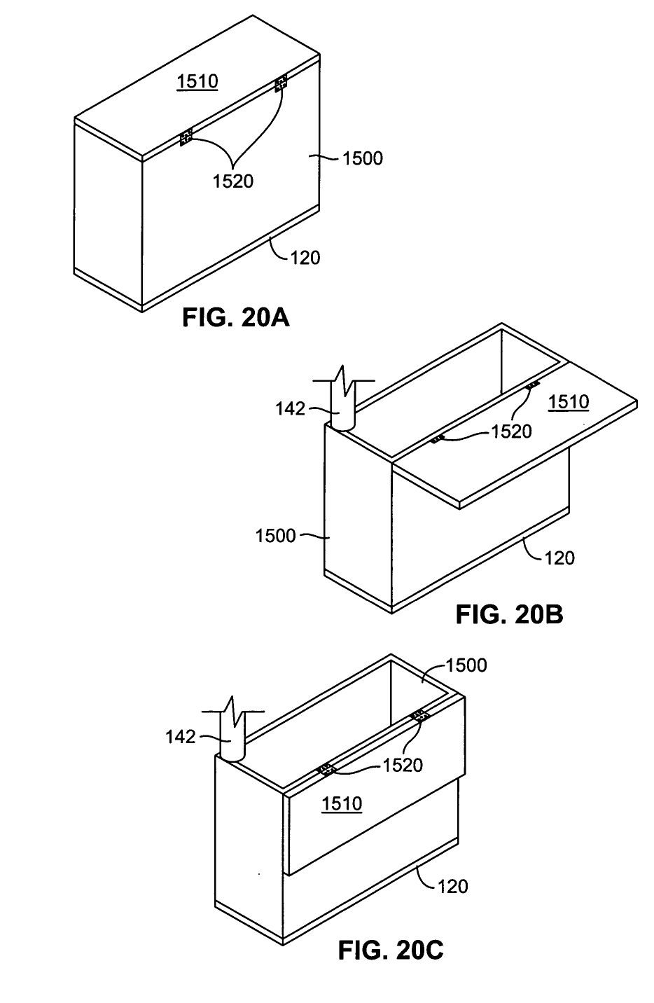

FIGS. 19 and 20 depict versions of the display stand 100 with enclosures about the base 120. FIG. 19 is an exploded isometric view of one such display stand 100 next to the chair 220 (FIG. 2), which could be any chair, such as, for example, the chair 800 (FIGS. 10 and 11) or the chair 900 (FIGS. 12-14). In this embodiment, the display stand 100 comprises an enclosure 1500. The enclosure 1500 may be a cabinet, box, or the like and can be made in any type of aesthetic style. For example, the enclosure 1500 can be made to resemble the style of the chair 220 or other furniture in the room in which the chair 220 is placed. The enclosure 1500 can be made of wood in the style of fine furniture that one would not hesitate to place in a “front room” or other formal place, unlike most other computer furniture. When not in use as a display stand, the enclosure 1500 may appear to be and may indeed function as an end table, especially when the vertical pole 142 is retractable and in its lowered state such that the vertical pole 142 and the display 200 (not shown) are contained within the enclosure 1500. The enclosure 1500 is preferably hollow inside and sized to fit the computer console 240, the keyboard 1020, and the display and lowered vertical pole 142, as described above. The enclosure 1500 preferably has slits, slots, vents, or other air passages to facilitate proper ventilation for any cooling fan associated with the computer console 240. The enclosure 1500 can also be made with a front door and/or a rear door to facilitate access to the drives and electrical ports on the computer console 240. Preferably, the console 240 is made to have all or most items to which access may be required (e.g., drives and ports) on the top side of the console 240 so that side doors are not necessary. If and where space permits, the interior of the enclosure 1500 can also optionally have pockets or pouches to hold items such as, for example, the keyboard 1020, a mouse, and books or manuals.

The enclosure 1500 shown in FIG. 19 has a removable top 1510, which may function as the lap desk 1010 (FIG. 13) or tray 1030 (FIG. 14) to hold the keyboard 1020. The top 1510 is shown in exploded form above the rest of the enclosure 1500 in FIG. 19. Although no deformable underside is shown for a lap desk, such can be included if desired. All or only a portion of the top 1510 can be made removable.

FIG. 20 is a set of isometric views of another version of the enclosure 1500. In this case, the top 1510 of the enclosure 1500 is hingedly attached to a side of the enclosure 1500 with hinges 1520. FIG. 20A shows the enclosure 1500 with the top 1510 closed, such as would typically be the case when the vertical pole 142 is retracted and the display 200 stowed away within the enclosure 1500. FIG. 20B shows one configuration with the top 1510 open and the vertical pole 142 raised. FIG. 20C shows the enclosure 1500 with the top 1510 open in another configuration. Hinges can be chosen suitable for either configuration. Some or all of the top 1510 can be swung open in this manner.

The enclosure 1500 may be separate from the chair 220, as shown in FIGS. 19 and 20, or it may be integrated with the chair 220. For example, the enclosure may be underneath an arm rest. Such an integrated embodiment would facilitate pre-wiring within the chair 220 of electrical cables for connection to and from the computer console 240 in the enclosure 1500.

The combination of a display stand as described herein and either a display, a chair, a computer (or other image-generating device), or some combination of the above is believed to synergistically enhance marketability of all such components. For example, merchants of computers may establish a marketing advantage by bundling a computer with a display stand and possibly a chair. This enables a computer merchant to differentiate itself from competitors based on non-electronic, stylistic factors. Similarly, chair merchants may establish a marketing advantage by bundling a display stand and possibly a computer with their chairs. Merchants of chairs and computers may beneficially form partnerships so that each can reach potential customers from the other's customer base.

The terms and descriptions used above are set forth by way of illustration only and are not meant as limitations. Those skilled in the art will recognize that many variations can be made to the details of the above-described embodiments without departing from the underlying principles of the invention. The scope of the invention should therefore be determined only by the following claims—and their equivalents—in which all terms are to be understood in their broadest reasonable sense unless otherwise indicated.

1. A display stand for use positioned to a side of a chair having a seat, a back, and an armrest, the display stand for holding an electronic display in a desirable position for comfortable viewing by a person seated in the chair, the display stand comprising:
a base;
a support arm having a proximate end and a distal end, the proximate end connected to the base; and
a connection for the display on the distal end of the support arm;
wherein the support arm is adjustable between a first configuration and a second configuration, the first configuration being characterized by the connection being positioned to the side of the chair and at a height approximately at or below the armrest, the second configuration being characterized by the connection being positioned at a height above the seat and forward of the back such that the person seated in the chair can comfortably view the electronic display, when connected to the connection.

2. A display stand according to claim 1, wherein the person seated in the chair can comfortably view the electronic display, when connected to the connection, in the second configuration when the back of the chair is reclined.

3. A display stand according to claim 1, wherein the person seated in the chair can comfortably view the electronic display, when connected to the connection, in the second configuration when the person raises his legs and extends his legs forward from the chair.

4. A display stand according to claim 1, wherein, in the second configuration, the connection is vertically and horizontally offset from the base at a position such that a moment arm caused by a weight of the display with respect to the base is countered by a weight of an item on a top side of the base, such that a bottom side of the base rests stably on or above a surface.

5. A display stand according to claim 1, wherein the support arm comprises:
a vertical pole having a bottom end that is connected to the base; and
a horizontally extending member having a proximate end and a distal end, the proximate end connected to the vertical pole at a second end of the vertical pole, the connection being located at the distal end of the horizontal arm.

6. A display stand according to claim 5, wherein the vertical pole is extendible and retractable vertically.

7. A display stand according to claim 6, further comprising:
an enclosure on the base.

8. A display stand according to claim 7, wherein the support arm and the connection are contained with in the enclosure in the first configuration.

9. A display stand according to claim 7, wherein the enclosure comprises a top and a plurality of sides, and wherein the top is hingedly connected to one of said sides.

10. A display stand according to claim 7, wherein the enclosure comprises a top and a plurality of sides, and wherein the top is separable and removable from the enclosure.

11. A display stand according to claim 10, wherein the top of the enclosure has a top side and a bottom side, the top side of the enclosure top being substantially flat and the bottom side of the enclosure top having a deformable shape such that the top of the enclosure can function as a lap desk for supporting a keyboard and/or mouse.

12. A display stand according to claim 10, wherein the chair comprises two arm rests disposed on opposite lateral sides of the seat, and wherein the top of the enclosure has a substantially flat top side and a width sufficient to rest on the armrests and thereby provide a surface for supporting a keyboard and/or mouse device.

13. A display stand according to claim 5, wherein the horizontally extending member is pivotable about the vertical pole.

14. A display stand according to claim 5, wherein the horizontally extending member comprises an inner member attached to the vertically extending member, and an outer member attached to the connection, wherein the outer member is slidably adjustable along the lengthwise direction of the inner member.

15. A display stand according to claim 5, wherein the vertical pole comprises an inner member attached to the base, and an outer member attached to the connection, wherein the outer member is slidably adjustable along the lengthwise direction of the inner member.

16. A display stand according to claim 1, wherein an image-generating machine is placed on the base and is electrically connected to the display so as to generate images on the display.

17. A display stand according to claim 16, wherein the image-generating machine is a computer, and the display is a computer monitor.

18. A display stand according to claim 1, wherein the display is a flat panel display.

19. A display stand according to claim 1, wherein the connection comprises:
a joint rotating the display in a horizontal plane; and
a joint rotating the pitch of the display upward or downward.

20. A combination comprising:
the display stand of claim 1; and
the display connected to the connection of the display stand.

21. A combination comprising:
the display stand of claim 1; and
an image generating machine placed on the base of the display stand.

22. A combination comprising:
the display stand of claim 1; and
the chair.

23. A combination comprising:
the display stand of claim 1;
the display connected to the connection of the display stand.
an image generating machine placed on the base of the display stand and electrically connected to the display so as to generate images on the display; and
the chair.

24. A chair comprising:
a generally horizontal seating surface;
a plurality of legs connected to the seating surface;
a seat back rearward from the seating surface;
an armrest positioned above and laterally from the seating surface;
a support arm having a proximate end and a distal end, the proximate end connected to at least one of the seating surface, legs, or seat back; and
a connection for an electronic display on the distal end of the support arm;
wherein the support arm is adjustable between a first configuration and a second configuration, the first configuration being characterized by the connection being positioned laterally from the seating surface and at a height approximately at or below the armrest, the second configuration being characterized by the connection being positioned at a height above the seating surface and forward of the seat back such that a person seated in the chair can comfortably view the electronic display, when connected to the connection.

25. A chair according to claim 24, further comprising:
the display.

26. A chair according to claim 24, further comprising:
an image-generating machine electrically connected to the electronic display.

27. A chair according to claim 26, wherein the image-generating machine is a computer.

28. A chair according to claim 27, wherein the computer is packaged in a case that is generally broader horizontally than its vertical height, the chair further comprising:
a platform underneath the seating surface dimensioned to hold the case.

29. A chair according to claim 24, further comprising:
a first speaker connection laterally on one side of the seat back at a height approximately where the head of the person would be; and
a second speaker connection laterally on the side opposite said one side of the seat back at a height approximately where the head of the person would be.

30. A chair according to claim 29, further comprising:
the first speaker; and
the second speaker.

31. A chair according to claim 24, wherein the chair is a recliner.

32. A chair according to claim 24, wherein the chair further comprises:
a foot rest.

33. A display stand for use positioned to a side of a chair having a seat, a back, an armrest, the display stand for holding an electronic display in a desirable position for comfortable viewing by a person seated in the chair, the display stand comprising:
a base;
a means for supporting the display vertically up from the base and horizontally away from the base; and
a means for connecting the display to a distal end of the means for supporting the display;
wherein the means for supporting the display is adjustable between a first configuration and a second configuration, the first configuration being characterized by the means for connecting the display being positioned to the side of the chair and at a height approximately at or below the armrest, the second configuration being characterized by the means for connecting the display being positioned at a height above the seat and forward of the back such that the person seated in the chair can comfortably view the electronic display, when connected to the means for connecting the display.
